(19) United States
(12) Patent Application Publication
(10) Pub. No.: US 2019/0383633 A1
(43) Pub. Date: Dec. 19, 2019

(54) METHOD OF PROVIDING TRANSPORTATION SERVICE TO PROTECT USER'S PERSONAL INFORMATION

(71) Applicant: LG Electronics Inc., Seoul (KR)

(72) Inventor: Jun Ho CHOI, Seoul (KR)

(21) Appl. No.: 16/556,353

(22) Filed: Aug. 30, 2019

(30) Foreign Application Priority Data
Aug. 20, 2019 (KR) 10-2019-0101916

(51) Int. Cl. G01C 21/36; H04W 4/021; G05D 1/00; G05D 1/02

(52) U.S. Cl. CPC G01C 21/3614; H04W 4/021; G05D 1/0287; G05D 1/0022; G01C 21/3644

(57) ABSTRACT

According to an embodiment, a method of providing a transportation service comprises receiving a departure location and a destination location from a user terminal, determining a nearby departure location based on the departure location, determining a nearby destination location according to a type of the destination location, and sending a request for dispatching a vehicle or a request for a driving route to a vehicle managing server based on the nearby departure location and the nearby destination location. The vehicles to which embodiments of the disclosure apply may be autonomous vehicles which may be associated with any artificial intelligence (AI) modules, drones, unmanned aerial vehicles, robots, augmented reality (AR) modules, virtual reality (VR) modules, or 5th generation (5G) mobile communication devices.

### CROSS-REFERENCE TO RELATED APPLICATION

The present disclosure claims priority to and the benefit of Korean Patent Application No. 10-2019-0101916, filed on Aug. 20, 2019 in the Korean Intellectual Property Office, the disclosure of which is incorporated herein by reference in its entirety.

### BACKGROUND

### 1. Field of the Invention

The present invention relates to methods of providing a transportation service to users while protecting the users' personal information.

### 2. Description of Related Art

In recent car hailing services, a user may send a request for a ride to the destination on an application installed on her mobile device to a transportation company, and the transportation company may dispatch a car to where the user is in.

A user may enter a destination via an audio-video-navigation (AVN) module or other vehicle human machine interface (HMI) equipped in the vehicle and travel to the destination while receiving a driving route to the destination and various types of driving information related to the driving route from a traffic information company.

Such way basically requires connection between the user's terminal (e.g., a mobile device or vehicle HMI) and the server of a service provider (e.g., a transportation company or traffic information company) over a network. To receive services, the user need provide her departure location information and destination location information to the service provider's server.

At each time of receiving services, the user's location information, which is personal information, may be cumulatively saved in the service provider's server, and this may increase concern about exposure of personal information.

Use of such a car hailing service or traffic information service in commute may put a user at risk of unintentional exposure of the departure location, e.g., her home location, and the destination location, e.g., her workplace location.

Thus, a need exists for a method for offering a transportation service to users without exposure of users' personal information to service providers.

### SUMMARY OF THE INVENTION

An object of the present invention is to change a departure location and destination location received from the user and request to dispatch a vehicle based on the changed locations or request a driving route.

Another object of the present invention is to selectively request a particular vehicle managing server to dispatch a vehicle according to the user's vehicle dispatch histories or to selectively request to dispatch a particular vehicle or a vehicle driven by a particular driver.

Another object of the present invention is to send requests for driving routes or driving information to different vehicle managing servers per section over the route to the destination.

The present invention is not limited to the foregoing objectives, but other objects and advantages will be readily appreciated and apparent from the following detailed description of embodiments of the present invention. It will also be appreciated that the objects and advantages of the present invention may be achieved by the means shown in the claims and combinations thereof.

To achieve the foregoing objectives, according to an embodiment, a method of providing a transportation service comprises receiving a departure location and a destination location from a user terminal, determining a nearby departure location based on the departure location, determining a nearby destination location according to a type of the destination location, and sending a request for dispatching a vehicle or a request for a driving route to a vehicle managing server based on the nearby departure location and the nearby destination location.

The present invention may change the departure location and destination location received from the user and request a driving route or to dispatch a vehicle based on the changed locations, thereby preventing the user's personal information from being exposed to the vehicle managing server.

The present invention may request a particular vehicle managing server to selectively dispatch a vehicle or to selectively dispatch a particular vehicle or a vehicle driven by a particular driver, thereby preventing the user's information from being cumulatively stored in any one vehicle managing server or any one vehicle and preventing any one driver from repeatedly perceiving the user's information.

The present invention may send requests for driving routes or driving information to different vehicle managing servers per section on the route to the destination, thereby preventing exposure of the user's entire driving route to the vehicle managing server.

The foregoing or other specific effects of the present invention are described below in conjunction with the following detailed description of the present invention.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a transportation service providing system according to an embodiment of the disclosure;

FIG. 2 is a flowchart illustrating a transportation service providing method according to an embodiment of the disclosure;

FIG. 3 is a block diagram illustrating internal configurations of a privacy server and a plurality of vehicle managing servers as illustrated in FIG. 1 according to an embodiment of the disclosure;

FIG. 4 is a view illustrating a nearby departure location and a nearby destination location according to an embodiment of the disclosure;

FIG. 5 is a flowchart illustrating a process for determining a nearby departure location according to an embodiment of the disclosure;

FIG. 6 is a flowchart illustrating a process for determining a nearby destination location according to an embodiment of the disclosure;

FIGS. 7A and 7B are tables illustrating vehicle dispatch histories corresponding to a user terminal according to an embodiment of the disclosure;

FIGS. 8 and 9 are views illustrating driving routes for a plurality of virtual sections according to an embodiment of the disclosure;

FIG. 10 is a view illustrating example operations of a user terminal and a privacy server in a 5G communication system, according to an embodiment of the disclosure; and

FIGS. 11, 12, 13, and 14 are views illustrating operation processes of a user terminal using 5G communication, according to an embodiment of the disclosure.

### DETAILED DESCRIPTION OF EXEMPLARY EMBODIMENTS

The foregoing objectives, features, and advantages are described below in detail with reference to the accompanying drawings so that the technical spirit of the present invention may easily be achieved by one of ordinary skill in the art to which the invention pertains. When determined to make the subject matter of the present invention unclear, the detailed description of the known art or functions may be skipped. Hereinafter, preferred embodiments of the present invention are described in detail with reference to the accompanying drawings. The same reference denotations are used to refer to the same or similar elements throughout the drawings.

The present invention relates to methods of providing a transportation service to users while protecting the users' personal information.

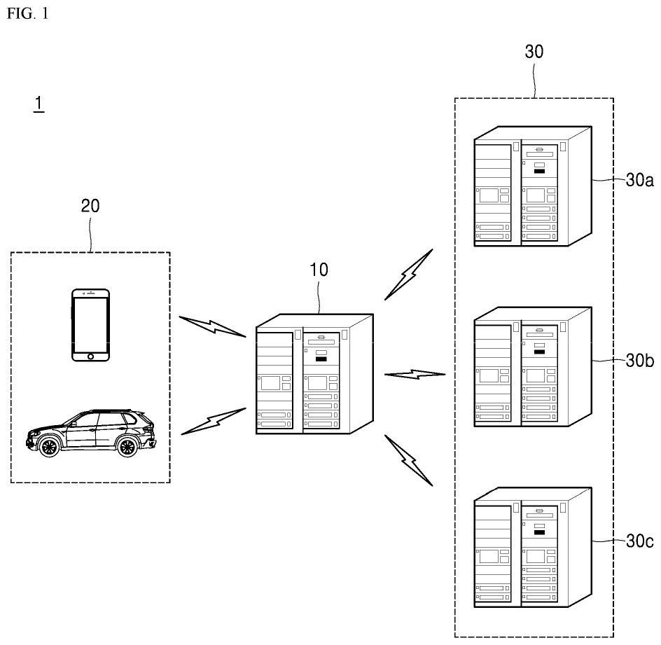

Described in detail below with reference to FIGS. 1 to 9 are a transportation service providing system and a method of providing a transportation service to a user using the system according to various embodiments of the disclosure.

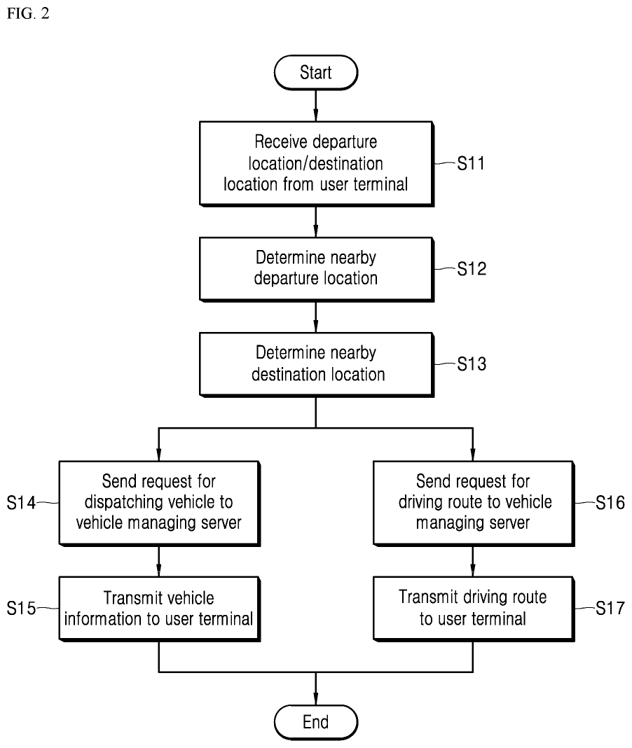

FIG. 1 is a view illustrating a transportation service providing system according to an embodiment of the disclosure. FIG. 2 is a flowchart illustrating a transportation service providing method according to an embodiment of the disclosure.

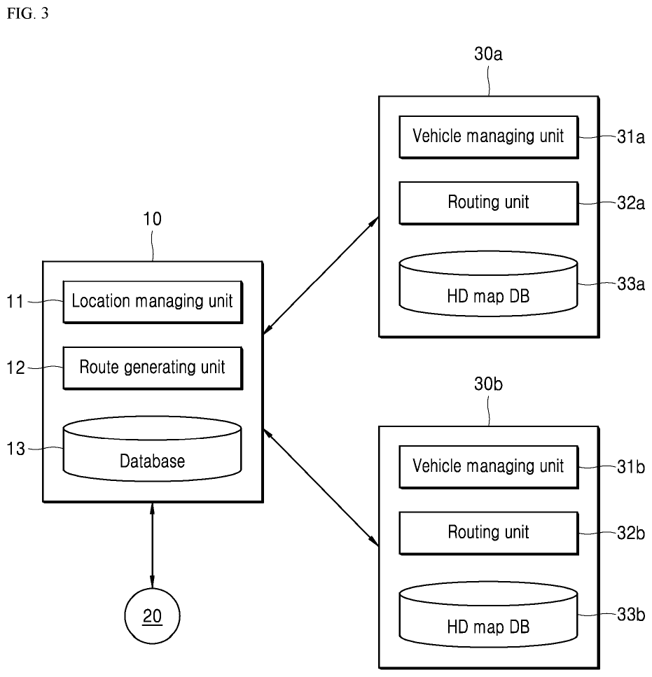

FIG. 3 is a block diagram illustrating internal configurations of a privacy server and a plurality of vehicle managing servers as illustrated in FIG. 1 according to an embodiment of the disclosure.

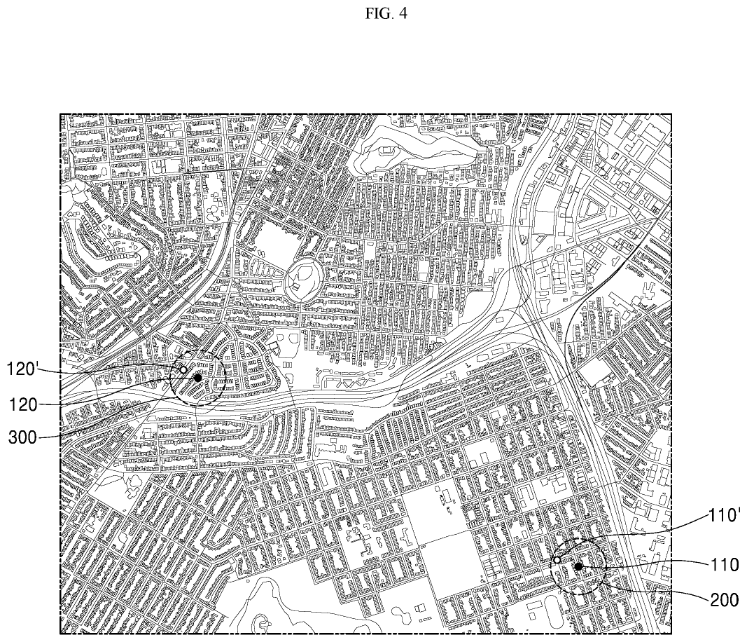

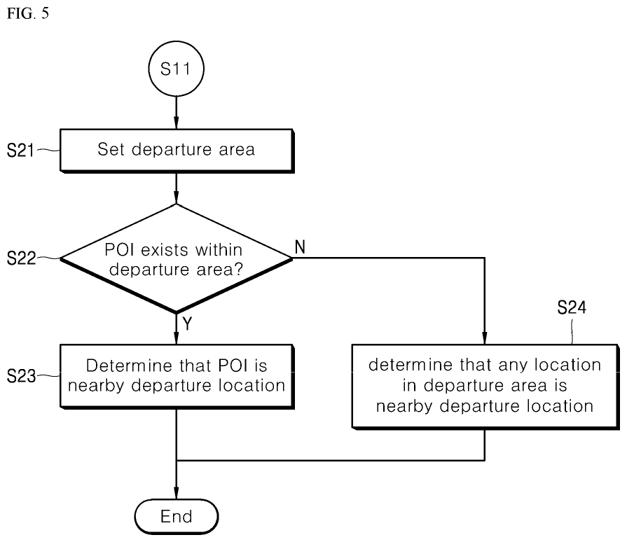

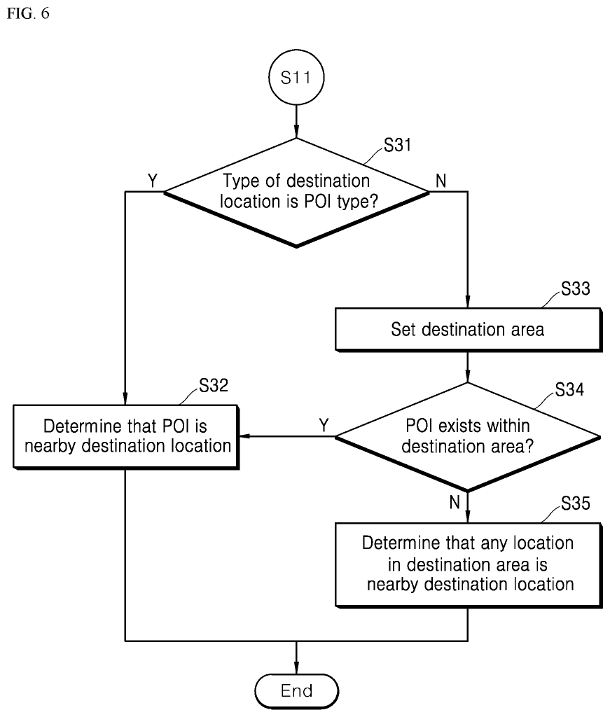

FIG. 4 is a view illustrating a nearby departure location and a nearby destination location according to an embodiment of the disclosure. FIG. 5 is a flowchart illustrating a process for determining a nearby departure location according to an embodiment of the disclosure. FIG. 6 is a flowchart illustrating a process for determining a nearby destination location according to an embodiment of the disclosure.

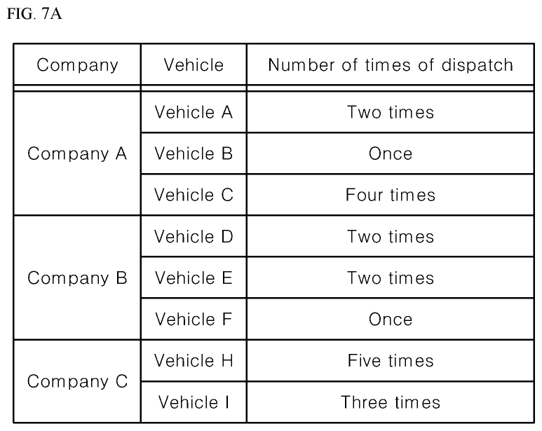

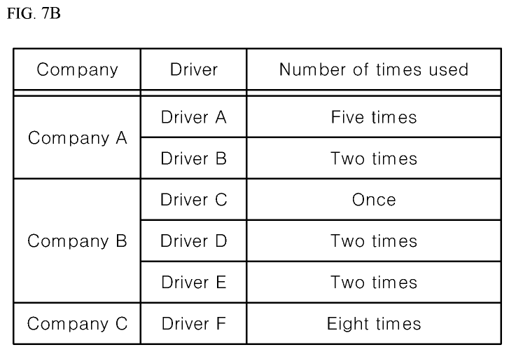

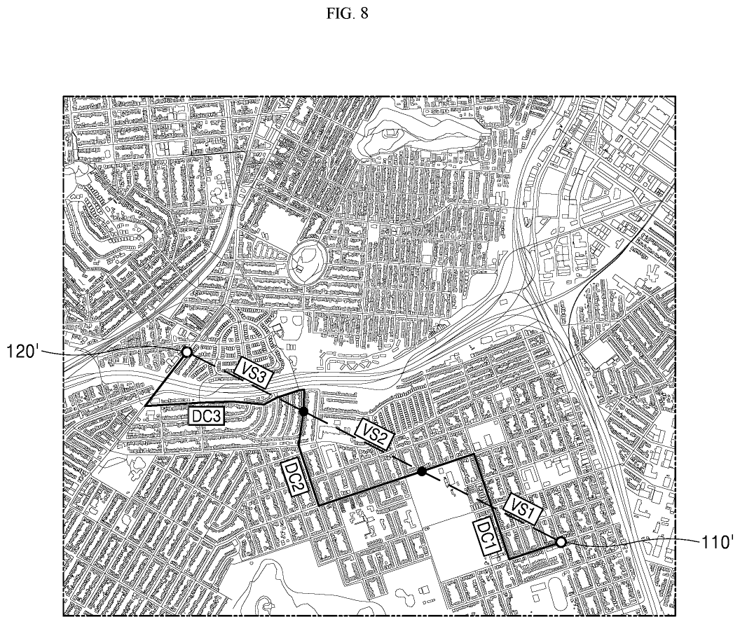

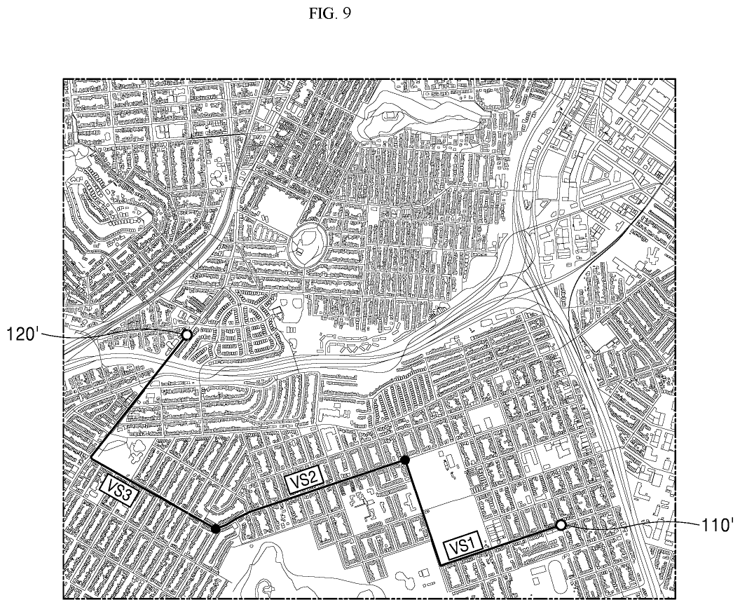

FIGS. 7A and 7B are tables illustrating vehicle dispatch histories corresponding to a user terminal according to an embodiment of the disclosure. FIGS. 8 and 9 are views illustrating driving routes for a plurality of virtual sections according to an embodiment of the disclosure.

Referring to FIG. 1, according to an embodiment, a transportation service providing system 1 may include a privacy server 10, a user terminal 20, and a plurality of vehicle managing servers 30. The privacy server 10, the user terminal 20, and the plurality of vehicle managing servers 30 constituting the transportation service providing system 1 may be connected together via a wireless network to perform data communication mutually, and each component may take advantage of a 5th generation (5G) communication system for data communication.

The user terminal 20 may be any terminal capable of performing wireless data communication. For example, the user terminal 20 may be implemented as a communication module-equipped vehicle or as a smartphone, tablet PC, or other mobile device.

Each vehicle managing server 30 may store and manage information gathered from the privacy server 10 and vehicles and may dispatch vehicles for the user's transportation and provide driving routes for guiding vehicles' driving. The vehicle managing servers 30 may be managed by a transportation company which operates vehicles (e.g., taxis or shared vehicles) and may be managed by any platform which provides the optimal driving routes for vehicles based on high-definition map information and traffic information.

The privacy server 10 may relay between the user terminal 20 and the vehicle managing servers 30. Specifically, the privacy server 10 may modulate the user's personal information gathered via the user terminal 20 and send requests for vehicles or driving routes to the vehicle managing servers 30 based on the modulated information.

A transportation service providing method described below may be performed by the privacy server 10. For example, the privacy server 10 may perform data communication with the user terminal 20 and the vehicle managing servers 30 and provide the user with a transportation service.

Referring to FIG. 2, according to an embodiment, the transportation service providing method may include receiving a departure location and a destination location from the user terminal 20 (S11), determining a nearby departure location (S12), and determining a nearby destination location (S13).

As an example, subsequent to the steps S11, S12, and S13, the transportation service providing method may include sending a request for dispatching a vehicle to a vehicle managing server 30 (S14) and transmitting vehicle information to the user terminal 20 (S15). As another example, subsequent to the steps S11, S12, and S13, the transportation service providing method may include sending a request for a driving route to a vehicle managing server 30 (S16) and transmitting the driving route to the user terminal 20 (S17).

The transportation service providing method shown in FIG. 2 is merely an example and is not limited to the steps of FIG. 2 but may rather add more steps or some of the steps may be modified or deleted as necessary.

Referring to FIG. 3, to perform the above-described transportation service providing method, the privacy server 10 may include a location managing unit 11, a route generating unit 12, and a database (DB) 13. To dispatch a vehicle or generate a driving route according to the above-described transportation service providing method, the plurality of vehicle managing servers 30a and 30b, respectively, may include vehicle managing units 31a and 31b, route directing units 32a and 32b, and high-definition (HD) map DBs 33a and 33b.

Each component in the privacy server 10 and the vehicle managing servers 30 may be implemented as at least one physical component of application specific integrated circuits (ASICs), digital signal processors (DSPs), digital signal processing devices (DSPDs), programmable logic devices (PLDs), field programmable gate arrays (FPGAs), processors, controllers, micro-controllers, or microprocessors.

The transportation service providing method of FIG. 2 is described with reference to the components shown in FIG. 3. The vehicles described below may be autonomous vehicles which may be associated with any artificial intelligence (AI) modules, drones, unmanned aerial vehicles, robots, augmented reality (AR) modules, virtual reality (VR) modules, or 5th generation (5G) mobile communication devices.

The privacy server 10 may receive a departure location and a destination location from the user terminal 20 (S11).

To travel to the destination in a vehicle, the user may enter the departure location and the destination location via the user terminal 20, and the user terminal 20 may transmit the entered departure location and destination location to the privacy server 10.

For example, the user may enter the departure location and the destination location via a transportation application installed on a mobile device, and the mobile device may transmit the entered locations to the privacy server 10. The user may enter the departure location and the destination location through a human machine interface (HMI) provided in the vehicle, and the vehicle may transmit the entered locations to the privacy server 10.

The location managing unit 11 in the privacy server 10 may receive the departure location and the destination location from the user terminal 20. The departure location and the destination location may be address information about the departure point and address information about the destination.

If the departure location and the destination location are received, the location managing unit 11 may determine a nearby departure location based on the departure location (S12).

Referring to FIG. 4, the nearby departure location 110′ may be a nearby location of the departure location 110. Specifically, the nearby departure location 110′ may fall within a preset radius (e.g., 500 m) of the departure location 110. The preset radius may be varied as necessary.

The location managing unit 11 may determine the nearby departure location 110′ depending on whether a point-of-interest (POI) is present within the preset radius of the departure point.

Specifically with reference to FIG. 5, the location managing unit 11 may set a departure area 200 based on the departure location 110 received from the user terminal 20 (S21). More specifically, the location managing unit 11 may set an area, which falls within a preset radius of the departure location 110, as the departure area 200.

Subsequently, the location managing unit 11 may determine whether there is a point-of-interest within the departure area 200 (S22). As used herein, ‘point-of-interest’ may refer to location information about a major facility which is noticeable on the map and may be location information about, e.g., a station, airport terminal, or hotel.

The point-of-interest may be included in the map information. The location managing unit 11 may determine whether the point-of-interest is present within the departure area 200 by referring to the map information stored in the database 13. Specifically, the location managing unit 11 may compare the location coordinates of the point-of-interest with the location coordinates of the departure area 200, thereby determining whether the point-of-interest falls within the departure area 200.

If the point-of-interest is determined in step S22 to be located within the departure area 200, the location managing unit 11 may determine that the point-of-interest is the nearby departure location 110′ (S23). In contrast, unless the point-of-interest is determined in step S22 to be located within the departure area 200, the location managing unit 11 may determine that any location in the departure area 200 is the nearby departure location 110′ (S24).

Next, the location managing unit 11 may determine a nearby destination location according to the type of the destination location (S13).

Referring back to FIG. 4, the nearby destination location 120′ may be a nearby location of the destination location 120. Specifically, the nearby destination location 120′ may fall within a preset radius (e.g., 500 m) of the destination location 120. The preset radius may be varied as necessary.

The destination location 120 may come in two types. For example, the destination location 120 may come in an address type and a point-of-interest type. If the destination location 120 is represented as address information, the destination location 120 may be of the address type and, if the destination location 120 is represented as point-of-interest information, the destination location 120 may be of the point-of-interest type.

For example, if the destination location 120 is expressed as address information, e.g., ‘375 Valencia St, San Francisco, Calif. 94103,’ the destination location 120 may be of the address type. If the destination location 120 is expressed as point-of-interest information, e.g., ‘San Francisco International Airport,’ the destination location 120 may be of the point-of-interest type.

A method of determining the nearby destination location 120′ according to the type of the destination location 120 by the location managing unit 11 is described in greater detail with reference to FIG. 6. The location managing unit 11 may receive address information about the destination or point-of-interest information corresponding to the destination, as the destination location 120, from the user terminal 20 (S11).

Then, the location managing unit 11 may determine whether the type of the destination location 120 is the address type or the point-of-interest type (S31). If the type of the destination location 120 is determined to be the point-of-interest type, the location managing unit 11 may determine that the point-of-interest corresponding to the destination is the nearby destination location 120′ (S32).

In contrast, if the type of the destination location 120 is determined in step S31 to be the address type, the location managing unit 11 may determine that any location within a preset radius of the destination location 120 is the nearby destination location 120′.

Specifically, the location managing unit 11 may set an area within a preset radius of the destination location 120 as the destination area 300 based on the destination location 120 (S33). Subsequently, the location managing unit 11 may determine that any location in the destination area 300 is the nearby destination location 120′ (S35).

In contrast, similar to the method described above in connection with FIG. 5, the location managing unit 11 may determine whether a point-of-interest is present within the destination area 300 (S34). The same determination method according to step S22 of FIG. 5 may apply to the determination of step S34.

If the point-of-interest is determined in step S34 to be located within the destination area 300, the location managing unit 11 may determine that the point-of-interest is the nearby destination location 120′. In contrast, unless the point-of-interest is determined in step S34 to be located within the destination area 300, the location managing unit 11 may determine that any location in the destination area 300 is the nearby destination location 120′.

The privacy server 10 may send a request for dispatching a vehicle or a request for a driving route to a vehicle managing server 30 based on the determined nearby departure location and the nearby destination location.

An embodiment in which the privacy server 10 sends a request for dispatching a vehicle to the vehicle managing server 30 is first described. This embodiment may relate to a scenario case in which the user requests to dispatch a vehicle on her mobile device.

The location managing unit 11 may send a request for dispatching a vehicle by transmitting information about the nearby departure location and the nearby destination location to any one of the plurality of vehicle managing servers 30. Specifically, the location managing unit 11 may request the vehicle managing server 30 to dispatch a vehicle which may drive from the nearby departure location to the nearby destination location.

The vehicle managing server 30 may search for vehicles which may drive from the nearby departure location to the nearby destination location and dispatch any one vehicle, which is closest to the nearby departure location among vehicles searched-for, to the nearby departure location.

As set forth above, the present invention may change the departure location and destination location received from the user and request to dispatch a vehicle based on the changed locations, thereby preventing the user's personal information (e.g., the departure location and destination location) from being exposed to the vehicle managing server 30.

The privacy server 10 may request any one of the plurality of vehicle managing servers 30 to dispatch a vehicle according to a vehicle dispatch history corresponding to the user terminal 20.

Vehicle dispatch histories according to the departure locations and destination locations received from user terminals 20 may be cumulatively stored per user terminal 20 in the database 13 of the privacy server 10.

Referring to FIG. 7A, the database 13 may previously store the number of times in which the vehicle managing server 30 of each company has dispatched vehicles as the vehicle dispatch history corresponding to a particular user terminal 20. Specifically, vehicles may have been dispatched to the user of the particular user terminal 20 seven times, five times, and eight times from the respective vehicle managing servers 30 of companies A, B, and C, respectively, and the numbers of times of vehicle dispatch per vehicle managing server 30 may be cumulatively stored in the database 13.

The location managing unit 11 may identify any one vehicle managing server 30 which has dispatched vehicles in a minimum number of times based on the vehicle dispatch histories and request the identified vehicle managing server 30 to dispatch a vehicle.

In the example shown in FIG. 7A, the location managing unit 11 may identify the vehicle managing server 30, which has dispatched vehicles in a minimum number of times based on the vehicle dispatch histories, as the vehicle managing server 30 of company B. Thus, the location managing unit 11 may request the vehicle managing server 30 of company B to dispatch a vehicle.

In response to the request from the privacy server 10, the vehicle managing unit 31 in the vehicle managing server 30 of company B may dispatch any one of vehicle D, vehicle F, and vehicle F to the user.

Further, the location managing unit 11 may send a request for dispatching any one dispatched in a minimum number of times among a plurality of vehicles managed by any one vehicle managing server 30 based on the vehicle dispatch histories.

In the above example, the location managing unit 11 may identify the vehicle managing server 30, which has dispatched vehicles in a minimum number of times based on the vehicle dispatch histories, as the vehicle managing server 30 of company B. Subsequently, the location managing unit 11 may identify any one vehicle, which has been dispatched in a minimum number of times among the vehicles operated by company B, as vehicle F based on the vehicle dispatch histories. Thus, the location managing unit 11 may request the vehicle managing server 30 of company B to dispatch vehicle F.

In response to the request from the privacy server 10, the vehicle managing unit 31 in the vehicle managing server 30 of company B may dispatch vehicle F to the user.

The location managing unit 11 may identify any one vehicle managing server 30 which has dispatched autonomous vehicles in a minimum number of times based on vehicle dispatch histories for autonomous vehicles and request the identified vehicle managing server 30 to dispatch an autonomous vehicle. As used herein, ‘autonomous vehicle’ may refer to a self-driving car which may drive to the destination

Referring back to FIG. 7A, the database 13 may previously store the numbers of times in which the respective vehicle managing servers 30 of companies have dispatched autonomous vehicles. In other words, the vehicles shown in FIG. 7A may be all autonomous vehicles. Specifically, autonomous vehicles may have been dispatched to the user of the particular user terminal 20 seven times, five times, and eight times from the respective vehicle managing servers 30 of companies A, B, and C, respectively, and the numbers of times of vehicle dispatch per vehicle managing server 30 may be cumulatively stored in the database 13.

As driverless, autonomous vehicles may be freed from exposure of the user's information to a driver. However, since the user's information is cumulative stored in the vehicle managing servers 30 operating the autonomous vehicles, the location managing unit 11, for the purpose of preventing the user's information to be cumulatively stored in a particular vehicle managing server 30, may request any one vehicle managing server 30, which has dispatched autonomous vehicles in a minimum number of times, to dispatch an autonomous vehicle.

In other words, in the example shown in FIG. 7A, the location managing unit 11 may identify the vehicle managing server 30, which has dispatched autonomous vehicles in a minimum number of times based on the vehicle dispatch histories, as the vehicle managing server 30 of company B. Thus, the location managing unit 11 may request the vehicle managing server 30 of company B to dispatch an autonomous vehicle.

In response to the request from the privacy server 10, the vehicle managing unit 31 in the vehicle managing server 30 of company B may dispatch any one of vehicle D, vehicle F, and vehicle F to the user.

The location managing unit 11 may identify the driver who has been used in a minimum number of times and any one vehicle managing server 30 operating the vehicle driven by the driver based on the vehicle dispatch histories and request the identified vehicle managing server 30 to dispatch the vehicle driven by the driver. Here, the vehicle may be a human-driving vehicle.

Referring to FIG. 7B, the database 13 may previously store the numbers of times in which the user of a particular user terminal 20 has used the drivers managed by the vehicle managing server 30 of each company.

For example, the user may thus far have used the vehicles, which are driven by driver A and driver B managed by company A, five times and two times, respectively, the vehicles, which are driven by driver C, driver D, and driver E managed by company B, once, two times, and two times, respectively, and the vehicle, which is driven by driver F managed by company C, eight times. The numbers of times in which drivers have been used per vehicle managing server 30 may be cumulatively stored in the database 13.

If the user makes use of the vehicle driven by the same driver multiple times, the user's information may be exposed to the driver. To prevent this situation, the location managing unit 11 may request any one vehicle managing server 30 to dispatch the vehicle which is driven by the driver who has been used in the minimum number of times.

Specifically, referring back to FIG. 7B, the location managing unit 11 may identify that driver C is the driver who has been used in the minimum number of times based on the numbers of times of use per driver and identify that the vehicle managing server 30 operating the vehicle driven by the driver is of company B. Thus, the location managing unit 11 may request the vehicle managing server 30 of company B to dispatch the vehicle driven by driver C.

In response to the request from the privacy server 10, the vehicle managing unit 31 in the vehicle managing server 30 of company B may dispatch any vehicle driven by driver C to the user.

As set forth above, the present invention may request a particular vehicle managing server 30 to selectively dispatch a vehicle or to selectively dispatch a particular vehicle or a vehicle driven by a particular driver, thereby preventing the user's information from being cumulatively stored in any one vehicle managing server 30 or any one vehicle and preventing any one driver from repeatedly perceiving the user's information.

If a vehicle to be dispatched is determined, the privacy server 10 may transmit information about the vehicle dispatched by the vehicle managing server 30 to the user terminal 20 (e.g., a mobile device). Thus, the user may figure out the vehicle which she is to ride.

Next, an embodiment in which the privacy server 10 sends a request for a driving route to a vehicle managing server 30 is described. This embodiment may involve a scenario case in which the user sends a request for a driving route via the HMI in the vehicle.

The location managing unit 11 may send a request for a driving route by transmitting information about the nearby departure location and the nearby destination location to any one of the plurality of vehicle managing servers 30. Specifically, the location managing unit 11 may send a request for a driving route from the nearby departure location to the nearby destination location to the vehicle managing server 30.

The routing unit 32 in the vehicle managing server 30 may generate a driving route from the nearby departure location to the nearby destination location based on a high-definition map stored in the HD map DB 33. Subsequently, the routing unit 32 may transmit the generated driving route to the privacy server 10.

As such, the present invention may change the departure location and destination location received from the user and send a request for a driving route based on the changed locations, thereby preventing the user's personal information (e.g., the departure location and destination location) from being exposed to the vehicle managing server 30.

The privacy server 10 may split the section between the nearby departure location and the nearby destination location into a plurality of virtual sections and send a request for a driving route for each virtual section to any one of a plurality of vehicle managing servers 30.

Referring to FIGS. 3 and 8, the route generating unit 12 in the privacy server 10 may split the straight section between the nearby departure location and the nearby destination location into three virtual sections VS1, VS2, and VS3. Subsequently, the route generating unit 12 may send a request for a driving route for each virtual section VS1, VS2, and VS3 to any vehicle managing server 30.

For example, the route generating unit 12 may send a request for a driving route for a first virtual section VS1 to a first vehicle managing server 30a. Thus, the routing unit 32a in the first vehicle managing server 30a may generate a first driving route DC1 from the start point of the first virtual section VS1 to the end point of the first virtual section VS1 based on the high-definition map and transmit the first driving route DC1 to the privacy server 10.

The route generating unit 12 may send a request for a driving route for a second virtual section V2 to a second vehicle managing server 30b. Thus, the routing unit 32b in the second vehicle managing server 30b may generate a second driving route DC2 from the start point of the second virtual section VS2 to the end point of the second virtual section VS2 based on the high-definition map and transmit the second driving route DC2 to the privacy server 10.

Likewise, the route generating unit 12 may send a request for a driving route for a third virtual section VS3 to any one of the plurality of vehicle managing servers 30, and the vehicle managing server 30 may generate a third driving route DC3 and transmit the third driving route DC3 to the privacy server 10.

In this case, the location managing unit 11 may individually send requests for driving routes for adjacent ones among the plurality of virtual sections to different vehicle managing servers 30.

Referring back to FIG. 8, the first driving route DC1 for the first virtual section VS1 may be generated by the first vehicle managing server 30a. In this case, the location managing unit 11 may send a request for the second driving route DC2 for the second virtual section VS2 to any vehicle managing server 30 among the plurality of vehicle managing servers 30 except for the first vehicle managing server 30a.

Thus, the second driving route DC2 for the second virtual section VS2 may be generated by the second vehicle managing server 30b. In this case, the location managing unit 11 may send a request for the third driving route DC3 for the third virtual section VS3 to any vehicle managing server 30 among the plurality of vehicle managing servers 30 except for the second vehicle managing server 30b.

The route generating unit 12 may send a request for a driving route for each virtual section VS1, VS2, and VS3 to the vehicle managing server 30 which has generated, more times, the driving route for each virtual sections VS1, VS2, and VS3.

For example, the first vehicle managing server 30a may have generated driving routes for the third virtual section VS3 more times than the other vehicle managing servers 30, and the second vehicle managing server 30b may have generated driving routes for the second virtual section VS2 more times than the other vehicle managing servers 30.

In this case, the route generating unit 12 may send a request for a driving route for the second virtual section VS2 to the second vehicle managing server 30b and a request for a driving route for the third virtual section VS3 to the first vehicle managing server 30a.

If the driving routes are received from the vehicle managing servers 30, the privacy server 10 may transmit the received driving routes to the user terminal 20 (e.g., the HMI in the vehicle). Thus, the user may drive the vehicle along the driving routes received from the privacy server 10.

The privacy server 10 may generate a virtual route from the nearby departure location to the nearby destination location and split the generated virtual route into a plurality of virtual sections. Then, the privacy server 10 may send a request for driving information about each split virtual section to any one of the plurality of vehicle managing servers 30.

As used herein, ‘driving information’ may refer to any information that may be referenced when driving a vehicle, and the driving information may include various pieces of information, such as the lane the vehicle drives on, the driving speed of the vehicle, the flatness and congestion of the road, locations and speeds of nearby vehicles, locations of traffic lights, locations of traffic cameras, locations of signs, road accident information, or road work information.

Referring to FIGS. 3 and 9, the route generating unit 12 in the privacy server 10 may generate a virtual route from the nearby departure location to the nearby destination location by referring to the map information stored in the database 13. Subsequently, the route generating unit 12 may split the generated virtual route into three virtual sections VS1, VS2, and VS3 and send a request for driving information about each virtual section VS1, VS2, and VS3 to any vehicle managing server 30.

For example, the route generating unit 12 may send a request for driving information about a first virtual section VS1 to a first vehicle managing server 30a. Accordingly, the routing unit 32a in the first vehicle managing server 30a may identify first driving information about the first virtual section VS1 by referring to the HD map DB 33a and transmit the identified first driving information to the privacy server 10.

The route generating unit 12 may send a request for driving information about a second virtual section V2 to a second vehicle managing server 30b. Accordingly, the routing unit 32b in the second vehicle managing server 30a may identify second driving information about the second virtual section VS2 by referring to the HD map DB 33b and transmit the identified second driving information to the privacy server 10.

Likewise, the route generating unit 12 may send a request for third driving information about a third virtual section VS3 to any one of the plurality of vehicle managing servers 30, and the vehicle managing server 30 may transmit the third driving information about the third virtual section VS3 to the privacy server 10.

In this case, the location managing unit 11 may individually send requests for driving information about adjacent ones among the plurality of virtual sections to different vehicle managing servers 30.

Referring back to FIG. 9, the first driving information about the first virtual section VS1 may be generated by the first vehicle managing server 30a. In this case, the location managing unit 11 may send a request for the second driving information about the second virtual section VS2 to any vehicle managing server 30 among the plurality of vehicle managing servers 30 except for the first vehicle managing server 30a.

Thus, the second driving information about the second virtual section VS2 may be generated by the second vehicle managing server 30b. In this case, the location managing unit 11 may send a request for the third driving information about the third virtual section VS3 to any vehicle managing server 30 among the plurality of vehicle managing servers 30 except for the second vehicle managing server 30b.

If the driving information is received from the vehicle managing servers 30, the privacy server 10 may transmit the received driving information to the user terminal 20 (e.g., the HMI in the vehicle). Thus, the user may drive the vehicle by referring to the driving information received from the privacy server 10.

As set forth above, the present invention may send requests for driving routes or driving information to different vehicle managing servers 30 per section on the route to the destination, thereby preventing exposure of the user's entire driving route to the vehicle managing server 30.

The data communication by the above-described transportation service providing system 1 may be performed over a 5G network. For example, data communication between the user terminal 20 and the privacy server 10 and data communication between the privacy server 10 and each vehicle managing server 30 may be performed over a 5G network.

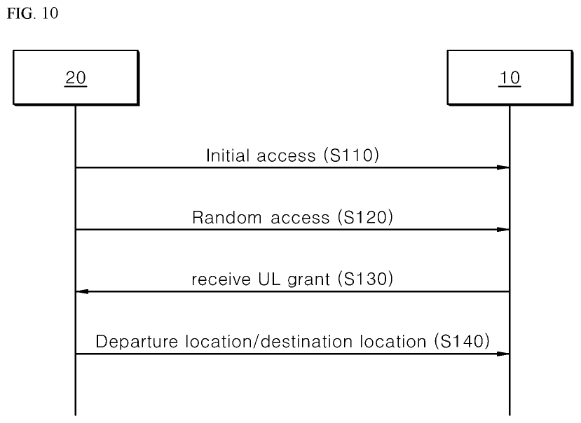

A data communication method over a 5G network is described below with reference to FIGS. 10 to 14. For illustration purposes, data communication between the user terminal 20 and the privacy server 10 is described as an example.

FIG. 10 is a view illustrating example operations of a user terminal and a privacy server in a 5G communication system, according to an embodiment of the disclosure.

The user terminal 20 may perform an initial access procedure with the privacy server 10 (S110).

The initial access procedure may include a cell search for obtaining a downlink (DL) operation and a process of obtaining system information.

The user terminal 20 may perform a random access procedure with the privacy server 10 (S120).

The random access procedure may include uplink (UL) synchronization, transmission of a preamble for UL data transmission, and a random access response reception process.

The privacy server 10 may transmit a UL grant for scheduling the transmission of the departure location/destination location to the user terminal 20 (S130).

UL grant reception may include the process of receiving a time/frequency schedule for transmission of UL data to the privacy server 10.

The user terminal 20 may transmit the departure location/destination location to the privacy server 10 based on the UL grant (S140).

Although not shown in FIG. 10, the user terminal 20 may receive a DL grant via a physical downlink control channel to receive vehicle information, driving route, and driving information from the privacy server 10. In this case, the privacy server 10 may transmit the vehicle information, driving route, and driving information to the user terminal 20 based on the DL grant.

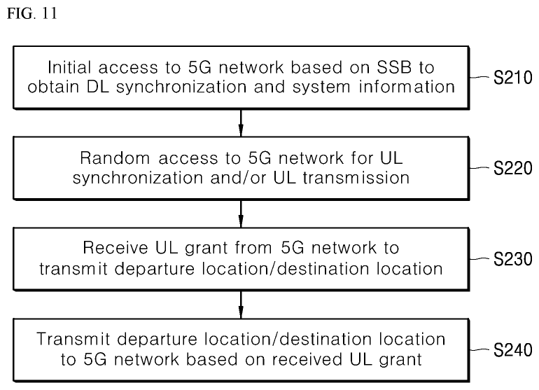

FIGS. 11 to 14 are views illustrating operation processes of a user terminal using 5G communication, according to an embodiment of the disclosure.

Referring to FIG. 11, the user terminal 20 may perform an initial access procedure with the privacy server 10 based on a synchronization signal block (SSB) to obtain system information and DL synchronization (S210).

The user terminal 20 may perform a random access procedure with the privacy server 10 for UL synchronization and/or UL transmission (S220).

The user terminal 20 may receive a UL grant from the privacy server 10 to transmit the departure location/destination location (S230).

The user terminal 20 may transmit the departure location/destination location to the privacy server 10 based on the UL grant (S240).

Step S210 may add a beam management (BM) process, step S31 may add a beam failure recovery process related to physical random access channel (PRACH) transmission, step S230 may add a QCL relation in relation to the beam reception direction of PDCCH containing a UL grant, and step S240 may add a QCL relation in relation to the beam transmission direction of physical uplink control channel (PUCCH)/physical uplink shared channel (PUSCH) containing the departure location/destination location.

Although not shown in FIG. 11, for receiving the vehicle information, driving route, and driving information from the privacy server 10, the user terminal 20 may receive a DL grant from the privacy server 10 and receive the vehicle information, driving route, and driving information from the privacy server 10 based on the DL grant.

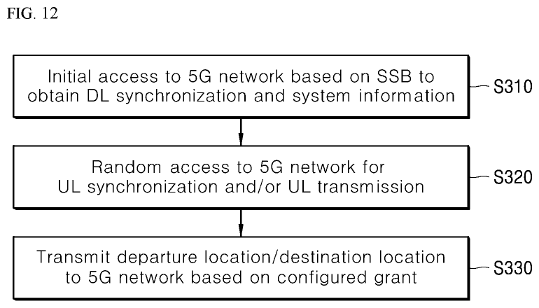

Referring to FIG. 12, the user terminal 20 may perform an initial access procedure with the privacy server 10 based on an SSB to obtain system information and DL synchronization (S310).

The user terminal 20 may perform a random access procedure with the privacy server 10 for UL synchronization and/or UL transmission (S320).

The user terminal 20 may transmit the departure location/destination location to the privacy server 10 based on a configured grant (S330). In other words, instead of receiving the UL grant from the privacy server 10, the departure location/destination location may be transmitted to the privacy server 10 based on the configured grant.

Although not shown in FIG. 12, for receiving the vehicle information, driving route, and driving information from the privacy server 10, the user terminal 20 may receive the vehicle information, driving route, and driving information from the privacy server 10 based on the configured grant.

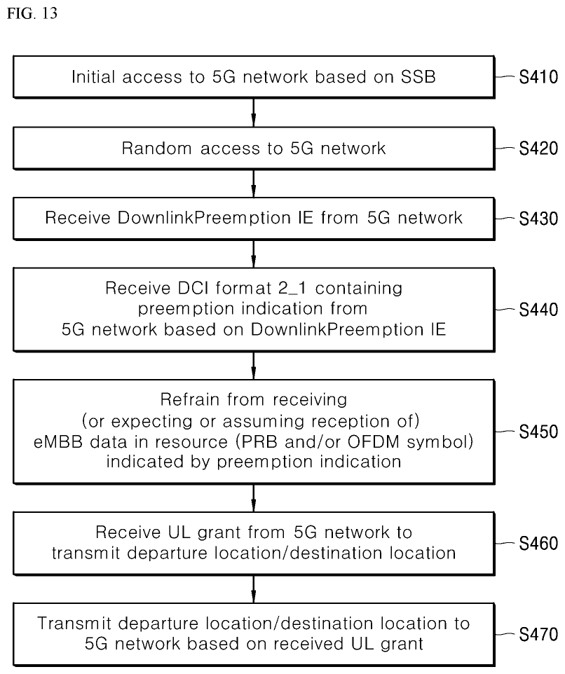

Referring to FIG. 13, the user terminal 20 may perform an initial access procedure with the privacy server 10 based on an SSB to obtain system information and DL synchronization (S410).

The user terminal 20 may perform a random access procedure with the privacy server 10 for UL synchronization and/or UL transmission (S420).

The user terminal 20 may receive a DownlinkPreemption IE from the privacy server 10 (S430).

The user terminal 20 may receive a DCI format 2_1 containing a preemption indication from the privacy server 10 based on the DownlinkPreemption IE (S440).

The user terminal 20 may refrain from receiving (or expecting or assuming the reception of) eMBB data in the resource (PRB and/or OFDM symbols) indicated by the preemption indication (S450).

The user terminal 20 may receive a UL grant from the privacy server 10 to transmit the departure location/destination location (S460).

The user terminal 20 may transmit the departure location/destination location to the privacy server 10 based on the UL grant (S470).

Although not shown in FIG. 13, for receiving the vehicle information, driving route, and driving information from the privacy server 10, the user terminal 20 may receive a DL grant from the privacy server 10 and receive the vehicle information, driving route, and driving information from the privacy server 10 based on the DL grant.

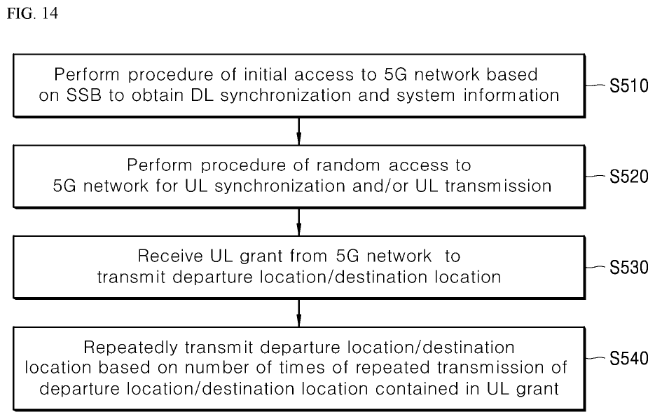

Referring to FIG. 14, the user terminal 20 may perform an initial access procedure with the privacy server 10 based on an SSB to obtain system information and DL synchronization (S510).

The user terminal 20 may perform a random access procedure with the privacy server 10 for UL synchronization and/or UL transmission (S520).

The user terminal 20 may receive a UL grant from the privacy server 10 to transmit the departure location/destination location (S530).

The UL grant may contain information about the number of times of repetition for transmission of the departure location/destination location, and the departure location/destination location may be repeatedly transmitted based on the number-of-times-of-repetition information (S540).

The user terminal 20 may transmit the departure location/destination location to the privacy server 10 based on the UL grant.

Repeated transmission of the departure location/destination location may be carried out via frequency hopping, and the first departure location/destination location may be transmitted in a first frequency resource, and the second departure location/destination location may be transmitted in a second frequency resource.

The departure location/destination location may be transmitted via a narrow band of 1 RB (resource block) or 6 RB.

Although not shown in FIG. 14, for receiving the vehicle information, driving route, and driving information from the privacy server 10, the user terminal 20 may receive a DL grant from the privacy server 10 and receive the vehicle information, driving route, and driving information from the privacy server 10 based on the DL grant.

Although examples of data communication between the vehicle and the privacy server 10 have been described above in connection with FIGS. 10 to 14, the above-described communication methods may also apply to any signals transmitted and received between the privacy server 10 and the vehicle managing server 30.

The 5G communication technology described above may be added to embody or clarify data communication methods performed in the transportation service providing system 1 according to the present invention. However, the present invention is not limited to the data communication methods and data communication may be performed by other various methods available in the technical field.

Various changes in form or detail may be made to the present invention by one of ordinary skill in the art without departing from the scope of the present invention, and the present invention is not limited to the above-described embodiments and the accompanying drawings.

What is claimed is:

1. A method of providing a transportation service, the method comprising:
receiving a departure location and a destination location from a user terminal;
determining a nearby departure location based on the departure location;
determining a nearby destination location according to a type of the destination location; and
sending a request for dispatching a vehicle or a request for a driving route to a vehicle managing server based on the nearby departure location and the nearby destination location.

2. The method of claim 1, wherein receiving the departure location from the user terminal includes receiving address information about a departure point.

3. The method of claim 1, wherein receiving the destination location from the user terminal includes receiving address information about a destination or point-of-interest (POI) information corresponding to the destination.

4. The method of claim 1, wherein the nearby departure location and the nearby destination location, respectively, fall within a preset radius of the departure location and a preset radius of the destination location.

5. The method of claim 1, wherein determining the nearby departure location based on the departure location includes determining that a POI is the nearby departure location when the POI is located within a preset radius of the departure location.

6. The method of claim 1, wherein determining the nearby destination location according to the type of the destination location includes, when the type of the destination location is an address type, determining that any location within a preset radius of the destination location is the nearby destination location.

7. The method of claim 6, wherein determining that the location within the preset radius of the destination location is the nearby destination location includes, when a POI is located within the preset radius of the destination location, determining that the POI is the nearby destination location.

8. The method of claim 1, wherein determining the nearby destination location according to the type of the destination location includes, when the type of the destination location is a POI type, determining that a POI corresponding to a destination is the nearby destination location.

9. The method of claim 1, wherein sending the request for dispatching the vehicle to the vehicle managing server includes sending a request for dispatching a vehicle which may drive from the nearby departure location to the nearby destination location.

10. The method of claim 1, wherein sending the request for dispatching the vehicle to the vehicle managing server includes sending the request to any one of a plurality of vehicle managing servers according to a vehicle dispatch history corresponding to the user terminal.

11. The method of claim 10, wherein sending the request to any one of the plurality of vehicle managing servers according to the vehicle dispatch history corresponding to the user terminal includes identifying any one vehicle managing server which has dispatched a minimum number of vehicles based on the vehicle dispatch history and sending a request for dispatching a vehicle to the identified vehicle managing server.

12. The method of claim 11, wherein sending the request to the identified vehicle managing server includes sending a request for requesting any one vehicle which has been dispatched in a minimum number of times among a plurality of vehicles managed by the identified vehicle managing server.

13. The method of claim 10, wherein sending the request to any one of the plurality of vehicle managing servers according to the vehicle dispatch history corresponding to the user terminal includes identifying any one vehicle managing server which has dispatched an autonomous vehicle in a minimum number of times based on the vehicle dispatch history for the autonomous vehicle and sending a request for dispatching an autonomous vehicle to the identified vehicle managing server.

14. The method of claim 10, wherein sending the request to any one of the plurality of vehicle managing servers according to the vehicle dispatch history corresponding to the user terminal includes identifying any one vehicle managing server operating a driver who has been used in a minimum number of times and a vehicle driven by the driver based on the vehicle dispatch history and sending a request for dispatching the vehicle driven by the driver to the identified vehicle managing server.

15. The method of claim 1, wherein sending the request for the driving route to the vehicle managing server includes sending a request for a driving route from the nearby departure location to the nearby destination location.

16. The method of claim 1, wherein sending the request for the driving route to the vehicle managing server includes splitting a section between the nearby departure location and the nearby destination location into a plurality of virtual sections and sending a request for a driving route for each virtual section to any one of a plurality of vehicle managing servers.

17. The method of claim 16, wherein sending the request for the driving route for each virtual section to any one of the plurality of vehicle managing servers includes sending requests for driving routes for adjacent ones among the plurality of virtual sections individually to different vehicle managing servers.

18. The method of claim 1, wherein sending the request for the driving route to the vehicle managing server includes generating a virtual route from the nearby departure location to the nearby destination location, splitting the generated virtual route into a plurality of virtual sections, and sending a request for driving information for each virtual section to any one of a plurality of vehicle managing servers.

19. The method of claim 18, wherein sending the request for the driving information for each virtual section to any one of the plurality of vehicle managing servers includes sending requests for driving information for adjacent ones among the plurality of virtual sections individually to different vehicle managing servers.

20. The method of claim 1, further comprising transmitting the driving route or information about a vehicle dispatched by the vehicle managing server to the user terminal.
